(19) United States
(12) Patent Application Publication
(10) Pub. No.: US 2012/0261087 A1
(43) Pub. Date: Oct. 18, 2012

(54) PROCESS FOR PRODUCING A MOLD

(76) Inventors: Masahiko Kagitani, Toyohashi-shi (JP); Yoshimitsu Ina, Toyohashi-shi (JP); Hitoshi Funada, Toyohashi-shi (JP)

(21) Appl. No.: 13/518,745

(22) PCT Filed: Dec. 20, 2010
(86) PCT No.: PCT/JP2010/072889

§ 371 Date: Jun. 22, 2012

(30) Foreign Application Priority Data
Dec. 24, 2009 (JP) 2009-292867

(51) Int. Cl. B22C 1/22; C08L 71/10; C09K 3/00; B22C 9/02

(52) U.S. Cl. 164/526; 524/611; 252/182.27

(57) ABSTRACT

A process for producing a mold, comprising a step of mixing refractory particles, a water-soluble phenol resin, and a curing agent composition comprising an ester compound, thereby yielding mixed sands, and a step of putting the mixed sands into an original pattern to shape the sands, wherein the refractory particles comprise reclaimed sands that are artificial sands produced by a fusion method in a proportion of 70% or more by weight, the curing agent composition comprises at least one selected from triethylene glycol diacetate, triethylene glycol, 3-phenylpropane-1-ol, and benzyl alcohol.

### TECHNICAL FIELD

The present invention relates to a curing agent composition used at the time of using refractory particles containing reclaimed sands that are artificial sands produced by a fusion method, and a water-soluble phenol resin; and a composition for a mold, and a process for producing a mold in each of which this curing agent composition is used.

### BACKGROUND ART

As a molding method for producing a mold, such as a master mold and a core, by use of a binder, a self-curing molding process is known. As the self-curing molding process, known is a molding process in which a water-soluble phenol resin, which is a binder, is cured by an ester curing agent.

As refractory particles used for molding, silica sands, zircon sands, chromite sands, olivine sands and the like have been widely used hitherto. As described in Patent Document 1 listed up below, in recent years, artificially synthetic mullite sands, which are produced by a sintering process using alumina silicate as a main component, have been gradually used since the sands are excellent in refractoriness (fire resistance), thermal expansibility, abrasion resistance, and crush resistance. Nowadays, in order to produce a mold having a high strength and a smooth surface, artificial sands produced by a fusion method have been used (Patent Document 2 listed up below, and others).

### PRIOR ART DOCUMENTS

### Patent Documents

Patent Document 1: JP-A-2000-153337

Patent Document 2: JP-A-2004-202577

### SUMMARY OF THE INVENTION

### Problems to be Solved by the Invention

However, in the case of using, as refractory particles, reclaimed sands that are artificial sands produced by a fusion method, and curing a water-soluble phenol resin with an ester curing agent to shape a mold, the drying of the mixed sands is considerably further promoted than in the case of using new sands, so that the former process becomes worse in workability. In the case of shaping, in particular, a large mold or a mold having a complicated shape, much time is required for a work of putting the mixed sands into an original mold; thus, hurried operations are forced to be made. Moreover, when dried portions of the mixed sands are incorporated thereinto, the resultant mold is deteriorated in strength or quality. In conventional self-curing molding processes, sufficient investigations have not been made about a matter that at the time of using reclaimed sands that are artificial sands produced by a fusion method, mixed sands therefrom are prevented from being dried. For reference, at the time of using reclaimed sands that are artificial sands produced by a sintering method, such a remarkable drying of the mixed sands is not recognized.

The present invention provides a curing agent composition making it possible that even when a working period for molding becomes long, the drying of the mixed sands is prevented; and a composition for a mold, and a process for producing a mold in each of which this curing agent composition is used.

### Solution to the Problems

The process of the present invention comprises a step of mixing refractory particles, a water-soluble phenol resin, and a curing agent composition comprising an ester compound, thereby yielding mixed sands, and a step of putting the mixed sands into an original pattern to shape the sands, wherein the refractory particles comprise reclaimed sands that are artificial sands produced by a fusion method in a proportion of 70% or more by weight, the curing agent composition comprises at least one selected from triethylene glycol diacetate, triethylene glycol, 3-phenylpropane-1-ol, and benzyl alcohol.

The composition of the present invention for a mold comprises refractory particles comprising reclaimed sands that are artificial sands produced by a fusion method in a proportion of 70% or more by weight, a water-soluble phenol resin, and a curing agent composition comprising an ester compound, and which comprises at least one selected from triethylene glycol diacetate, triethylene glycol, 3-phenylpropane-1-ol, and benzyl alcohol.

The curing agent composition of the present invention comprises an ester compound, and is used at the time of using refractory particles comprising reclaimed sands that are artificial sands produced by a fusion method in a proportion of 70% or more by weight, and a water-soluble phenol resin to produce a mold, and which comprises at least one selected from triethylene glycol diacetate, triethylene glycol, 3-phenylpropane-1-ol, and benzyl alcohol.

### Effects of the Invention

According to the curing agent composition of the present invention, the drying of the mixed sands can be prevented even when a working period for molding becomes long. Moreover, according to the composition for a mold and process for producing the mold of the present invention, the molding process becomes good in workability, and further the mold can be prevented from being lowered in strength.

### MODES FOR CARRYING OUT THE INVENTION

The curing agent composition of the present invention is concerned with a curing agent composition used at the time of using refractory particles comprising reclaimed sands that are artificial sands produced by a fusion method in a proportion of 70% or more by weight, and a water-soluble phenol resin to produce a mold. Hereinafter, a description is made about the components contained in the curing agent composition of the present invention.

<Components for Preventing Mixed Sands from Being Dried>

The curing agent composition of the present invention may contain at least one selected from triethylene glycol, 3-phenylpropane-1-ol, and benzyl alcohol as a component for preventing the mixed sands from being dried (hereinafter referred to as a drying preventing component). It is preferred from the viewpoint of the prevention of the drying of the mixed sands that the composition contains at least one selected from triethylene glycol, and benzyl alcohol.

In the case of using, as the drying preventing component, at least one selected from triethylene glycol, 3-phenylpropane-1-ol, and benzyl alcohol, the content by percentage ;i.e., the proportion) thereof is preferably 2% or more by weight, more preferably 4% or more by weight, even more preferably 8% or more by weight from the viewpoint of the prevention of the drying of the mixed sands. From the viewpoint of the strength of the mold, the content by percentage of at least one selected from triethylene glycol, 3-phenylpropane-1-ol, and benzyl alcohol is preferably 50% or less by weight, more preferably 40% or less by weight, even more preferably 30% or less by weight. Considering the viewpoints totally, the content by percentage of at least one selected from triethylene glycol, 3-phenylpropane-1-ol, and benzyl alcohol is preferably from 2 to 50% by weight, more preferably from 4 to 40% by weight, even more preferably from 8 to 30% by weight.

<Ester Compound>

The curing agent composition of the present invention contains an ester compound as a component for curing a water-soluble phenol resin. The ester compound may be an ester compound that is known in the prior art and is usable as a curing agent for a water-soluble phenol resin. The ester compound is preferably an ester compound having, in the molecule thereof, 1 to 5 ester bonds from the viewpoint of the performance of curing the water-soluble phenol resin. Examples thereof include lactones, organic esters each induced from a monohydric or polyhydric alcohol having 1 to 10 carbon atoms, and an organic carboxylic acid having 1 to 10 carbon atoms, and inorganic esters such as ethylene carbonate, and propylene carbonate. Of these examples, the organic esters are preferred from the viewpoint of the strength of the mold. As for the organic esters, the moiety originating from their carboxylic acid may be linear or branched. The branched chain is preferably a chain branched at the α-position. Specific examples of the organic esters include γ-butyrolactone, ethyl formate, ethylene glycol diacetate, ethylene glycol monoacetate, triethylene glycol diacetate, triacetin, ethyl acetoacetate, dimethyl succinate, dimethyl glatarate, dimethyl adipate, dimethyl 2-ethylsuccinate, dimethyl 2-methylglutarate, dimethyl 2-methyladipate, methyl 2-ethylhexanoate, ethyl 2-ethylhexanoate, dimethyl 2-methylsebacate, dimethyl 2-ethylazelate, diethyl 2-ethylgultarate, dimethyl 2-(n-propyl)glutarate, diethyl 2-(n-butyl)succinate, dimethyl 2-(n-butyl)succinate, diethyl 2-methylpimelate, dimethyl 2-methylsuberate and the like. From the viewpoint of the mold strength, γ-butyrolactone, and ethyl formate are preferred when the air temperature or the sand temperature is low or when the working period is short. When the air temperature or the sand temperature is high or when the working period is long, preferred are ethyl acetoacetate, dimethyl succinate, dimethyl glutarate, dimethyl adipate, dimethyl 2-ethylsuccinate, dimethyl 2-methylglutarate, and dimethyl 2-methyladipate. When the air temperature or the sand temperature is not high or low, or when the working period is not long or short, preferred are triethylene glycol diacetate, triacetin, and ethylene glycol diacetate. In the present invention, these ester compounds may be used alone or in the form of a mixture of two or more thereof. When triethylene glycol diacetate is used as the ester compound, the composition may not contain any drying preventing component since triethylene glycol diacetate has an effect of drying-prevention.

The content by percentage of the ester compound in the curing agent composition is preferably 50% or more by weight, more preferably 60% or more by weight, even more preferably 70% or more by weight from the viewpoint of the mold strength. From the viewpoint of the prevention of an excessive promotion of the curing reaction and an improvement in various properties of the mold, the content by percentage of the ester compound in the curing agent composition is preferably 98% or less by weight, more preferably 96% or less by weight, even more preferably 94% or less by weight. Considering these viewpoints totally, the content by percentage of the ester compound in the curing agent composition is preferably from 50 to 98% by weight, more preferably from 60 to 96% by weight, even more preferably from 70 to 94% by weight.

In the case of using triethylene glycol diacetate as the ester compound, from the viewpoint of the mold strength the content by percentage thereof is preferably from 1 to 20% by weight when the air temperature or the sand temperature is low or when the working period is short, and the content by percentage is preferably from 30 to 98% by weight when the air temperature or the sand temperature is high or when the working period is long.

It is essential from the viewpoint of the prevention of the drying that the curing agent composition of the present invention contains one or more selected from triethylene glycol diacetate, triethylene glycol, 3-phenylpropane-1-ol, and benzyl alcohol.

A preferred combination of the drying preventing component and the ester compound is a combination of one or more selected from triethylene glycol, 3-phenylpropane-1-ol, and benzyl alcohol with triethylene glycol diacetate from the viewpoint of the compressive strength of the mixed sands after 24 hours from a time when the raw materials are mixed with each other and immediately the resultant mixed sands are put into an original pattern. A more preferred combination is a combination of one or more selected from triethylene glycol, and benzyl alcohol with triethylene glycol diacetate. The ratio by weight of one or more selected from triethylene glycol, 3-phenylpropane-1-ol, and benzyl alcohol to one or more selected from triethylene glycol diacetate, triacetin, and ethylene glycol diacetate, which are each an ester compound, is preferably from 4/96 to 30/70, more preferably from 10/90 to 25/75 from the viewpoint of the compressive strength of the mixed sands after 24 hours from a time when the raw materials are mixed with each other and immediately the resultant mixed sands are put into an original pattern. The ratio by weight of one or more selected from triethylene glycol, and benzyl alcohol to one or more selected from triethylene glycol diacetate, triacetin, and ethylene glycol diacetate, which are each an ester compound, is preferably from 4/96 to 30/70, more preferably from 10/90 to 25/75 from the viewpoint of the compressive strength of the mixed sands after 24 hours from a time when the raw materials are mixed with each other and immediately the resultant mixed sands are put into an original pattern.

<Other Components>

The curing agent composition of the present invention may contain a phenolic compound monomer, and may contain additives such as a perfume, a surfactant and the like as far as the advantageous effects of the present invention are not damaged.

Phenolic Compound Monomer:

The curing agent composition of the present invention may contain a phenolic compound monomer. Even when the outside air temperature is high (for example, 40° C. or higher), this embodiment makes it possible to prolong the usable period (of the mold composition) without lowering the final strength of the mold.

Examples of the phenolic compound monomer include phenol, cresol, xylenol, cumylphenol, nonylphenyl, butylphenol, phenylphenol, ethylphenol, octylphenol, amylphenol, naphthol, resorcin, bisphenol A, bisphenol F, bisphenol C, catechol, hydroquinone, pyrogallol, and phloroglucin; and mixtures thereof or the like. Furthermore, use may be made of a resorcin residue, a bisphenol A residue, chlorophenol, dichlorophenol and the like, or a substituted phenol and the like. In the present invention, these phenolic compound monomers may be used alone or in the form of a mixture of two or more thereof. When the composition preferably contains resorcin or bisphenol A out of these monomers or more preferably contains resorcin, the bench life can be further prolonged without lowering the final strength of the mold.

When the curing agent composition of the present invention contains the phenolic compound monomer, the content by percentage thereof in the curing agent composition is preferably 1% or more by weight, more preferably 2% or more by weight from the viewpoint of the prolongment of the bench life. From the viewpoint of the maintenance of the final strength, the content by percentage of the phenolic compound monomer in the curing agent composition is preferably 30% or less by weight, more preferably 20% or less by weight. Considering these viewpoints totally, the content by percentage of the phenolic compound monomer in the curing agent composition is preferably from 1 to 30% by weight, more preferably from 2 to 20% by weight.

Surfactant:

The curing agent composition of the present invention may contain a surfactant as far as the advantageous effects of the present invention are not damaged. It is preferred that the composition contains, in particular, a nonionic surfactant such as polyoxyethylene (5) lauryl ether since odor emitted from the mixed sands can be decreased. The addition amount of these additives is preferably from 0.001 to 20 parts by weight for 100 parts by weight of the ester compound.

Even when the above-mentioned drying preventing component or triethylene glycol diacetate is not contained in the curing agent composition but separately added thereto in the present invention, the same advantageous effects as described above can be obtained. In other words, the composition of the present invention for a mold is a mold composition which comprises refractory particles comprising reclaimed sands that are artificial sands produced by a fusion method in a proportion of 70% or more by weight, a water-soluble phenol resin, and a curing agent composition comprising an ester compound, and which comprises at least one selected from triethylene glycol diacetate, triethylene glycol, 3-phenylpropane-1-ol, and benzyl alcohol. In the mold composition of the present invention, one or more selected from triethylene glycol diacetate, triethylene glycol, 3-phenylpropane-1-ol, and benzyl alcohol may be contained as one component species of the curing agent composition, or may be contained as one component species for the water-soluble phenol resin. When the refractory particles, the water-soluble phenol resin, and the curing agent composition are mixed with each other, the one or more components may be separately added thereto. The timing when the drying preventing component or triethylene glycol diacetate is added in this case is not particularly limited.

Even when the other components that can be contained in the curing agent composition of the present invention are not contained in the curing agent composition but separately added thereto, the same advantageous effects as described above can be obtained. In other words, a phenolic compound monomer such as resorcin, or additives such as a perfume and a surfactant may each be contained as one component of the curing agent composition, or contained as one component for the water-soluble phenol resin. These may be separately added when the refractory particles, the water-soluble phenol resin and the curing agent composition are mixed with each other. The timing when the other components are added is not particularly limited as far as after the preparation of the mold composition (mixed sands) the composition contains the phenolic compound monomer such as resorcin, or the other additives such as the perfume and/or the surfactant.

Next, a description is made about the process of the present invention for producing a mold. According to the process of the present invention for producing a mold, a mold is produced from a mold composition (mixed sands) obtained by adding, to refractory particles, the curing agent composition of the present invention, and a water-soluble phenol resin. Specifically, the process of the present invention for producing a mold includes the step of mixing refractory particles, a water-soluble phenol resin, and the curing agent composition of the present invention with each other, thereby yielding mixed sands, and the step of putting the mixed sands into an original pattern to shape the sands, wherein the refractory particles comprise reclaimed sands that are artificial sands produced by a fusion method in a proportion of 70% or more by weight. It is preferred from the viewpoint of an improvement in the workability of the mold production and the mold strength that a phenolic compound monomer, in particular, resorcin is contained as one of the above-mentioned additive components in the mixed sands. It is more preferred that the monomer is contained in the curing agent composition. Hereinafter, the components contained in the mixed sands used in the process of the present invention for the production of molds will be described. Any description that overlaps with the description of the curing agent composition of the present invention is omitted.

<Refractory Particles>

In the present invention, refractory particles are used which comprise reclaimed sands that are artificial sands produced by a fusion method in a proportion of 70% or more by weight. The mold composition may contain silica sands, zircon sands, chromite sands, olivine sands, cement sands or other sands as refractory particles other than the reclaimed sands, which are artificial sands produced by a fusion method. The composition may contain artificial sands produced by a sintering method.

In order that the curing agent composition of the present invention may more effectively produce the above-mentioned advantageous effects (the prevention of the drying of the mixed sands), it is preferred that the refractory particles used in the present invention contain the reclaimed sands in a proportion of about 100% by weight. The wording “contain the reclaimed sands in a proportion of about 100% by weight” means that when refractory particles other than the reclaimed sands are inevitably incorporated into the mold composition, the incorporation is allowable as far as the proportion thereof is 2% or less by weight.

The artificial sands produced by a fusion method denote artificial sands obtained by using, for example, alumina and silica as starting materials, fusing the materials by heat or some other, and particulating the materials. The artificial sands are preferably alumina sands containing alumina in a proportion of 40% or more by weight, more preferably alumina sands containing alumina in a proportion of 55 to 90% by weight, even more preferably alumina sands containing alumina in a proportion of 67 to 90% by weight, in particular, from the viewpoint of the refractoriness and the productivity (of the mold).

The method for particulating the fused starting materials may be a method of spraying the fused materials, a method of blowing the air into the fused materials, or some other method. Specifically, the fused materials are flied and crushed in the air into particles having a predetermined particle size distribution; and after the crushing, the fused particles are turned to cast sands (refractory particles) having a predetermined surface area by the surface tension of the particles themselves. The method for the fusion is not particularly limited, and the starting materials may be fused by means of an arc furnace, a crucible furnace, an electric induction furnace (such as a high frequency furnace and a low frequency furnace), an electric resistance furnace, a reverberatory furnace, a rotary furnace, a vacuum fusion furnace, a cupola furnace or some other furnace. Alternatively, use may be made of a method of fusing the starting materials in flame to be made into the form of spheres (flame fusion method).

The starting materials of the artificial sands may be selected from, for example, mining-produced materials or synthetic materials having refractoriness. For example, a source for alumina may be, for example, bauxite, aluminous shale, aluminum oxide, aluminum hydroxide or the like. A source for silica may be, for example, silica rock, silica sand, quartz, cristobalite, amorphous silica, feldspar, pyrophyllite or the like. A source for alumina and silica may be, for example, kaolin, aluminous shale, bauxite, mica, sillimanite, andalusite, mullite, zeolite, montmorillonite, hydrosite or the like. These starting materials maybe used alone or in the form of a mixture of two or more thereof.

The reclaimed sands usable in the present invention are sands yielded by subjecting sands obtained by crushing a casting produced by aid of a mold shaped by use of a water-soluble phenol resin to regenerating treatment one or more times in an ordinary regenerating manner (such as a wet, dry and hot manner). Sands reclaimed in a dry manner (in particular, an abrading manner) are preferred since the sands are high in yield to be economically good. The sands obtained by the crushing may be reclaimed by a combination of two or more of these manners.

From the viewpoint of an improvement in the strength of the mold, about the reclaimed sands usable in the present invention, the loss on ignition (LOI) thereof is preferably from 0.1 to 20% by weight, more preferably from 0.2 to 10% by weight, even more preferably from 0.2 to 5% by weight, and even more preferably from 0.2 to 2.0% by weight. The LOI denotes the percentage of a reduction in the weight that results from an operation that the sands are heated in the air at 500° C. for 2 hours.

<Water-Soluble Phenol Resin>

The water-soluble phenol resin usable in the process of the present invention for producing a mold is a resin curable with an ester compound, and is generally a resin yielded by causing a phenolic compound and an aldehyde compound to undergo polycondensation under an alkaline condition. As the phenolic compound, the following may be used: phenol, bisphenol A, bisphenol F, cresol, 3,5-xylenol, resorcin, catechol, nonylphenol, p-tert-butylphenol, isopropenylphenol, phenylphenol, or any other phenolic compound that may be a substituted phenolic compound; or a mixture of various phenolic compounds, such as cashew nut shell liquid. In the production, these may be used alone or in the form of a mixture of two or more thereof. As the aldehyde compound, the following may be used alone or in the form of a mixture of two or more thereof: formaldehyde, furfural, glyoxal, and others. These compounds may each be used in the form of an aqueous solution as the need arises. It is allowable to blend therewith a monomer condensable with the aldehyde compound, such as urea, melamine and cyclohexanone, a monohydric aliphatic alcohol compound, such as methanol, ethanol, isopropanol alcohol, n-propyl alcohol and butyl alcohol, a polyacrylic acid salt of a water-soluble polymer, a cellulose derivative polymer, polyvinyl alcohol, a lignin derivative, and the like.

An alkaline catalyst used to synthesize the water-soluble phenol resin may be a hydroxide of an alkali metal, such as LiOH, NaOH and KOH, and is in particular preferably NaOH or KOH. These alkaline catalysts may be used in a mixture form.

In the synthesis of the water-soluble phenol resin, the ratio by mole of the aldehyde compound to the phenolic compound is from 1.0 to 6.0, more preferably from 1.1 to 5.5. The ratio by mole of the alkaline catalyst to the phenolic compound is preferably from 0.2 to 5.0, more preferably from 0.5 to 4.0.

In the present invention, the solid weight-content by percentage in the water-soluble phenol resin (the solid weight-content by percentage therein after the resin is dried at 105° C. for 3 hours) is preferably from 25 to 90% by weight, more preferably from 30 to 85% by weight from the viewpoint of the mold strength. The weight-average molecular weight (Mw) of the water-soluble phenol resin is preferably from 500 to 8000, more preferably from 800 to 5000 from the viewpoint of the mold strength.

The weight-average molecular weight (Mw) of the water-soluble phenol resin may be measured by GPC (gel permeation chromatography) under conditions described below.

Method for Measuring Weight-Average Molecular Weight of Water-Soluble Phenol Resin:
(a) Sample preparation: to a sample is added ion exchange water having a weight equal to that of the sample, and then thereto is added 0.1% by weight H₂SO₄ to neutralize the solution. The generated precipitation is separated by filtration, washed with water and then dried. This is dissolved in tetrahydrofuran (THF) to prepare a sample for GPC.
(b) Column: use was made of a guard column TSX (manufactured by Tosoh Co., Ltd.) HXL (4 cm×6.5 mm in diameter), a column TSK3000HXL (30 cm×7.8 mm in diameter) and a column TSK2500HXL (30 cm×7.8 mm in diameter). From the injection port side (concerned), the guard column, the column 3000HXL, and the column 2500HXL were successively connected thereto.
(c) Standard substance: polystyrene (manufactured by Tosoh Co., Ltd.)
(d) Eluent: THF (flow rate: 1 cm³/min.)
(e) Column temperature: 25° C.
(f) Detector: ultraviolet spectrophotometer (quantitative determination at the wavelength at a maximum peak in the ultraviolet absorption of phenol)
(g) Sharing method for calculating the molecular weight: time sharing (2 sec.)

In the present invention, a mold can be produced, using a conventional self-curing molding process as it is. The temperature of the mixed sands when the sands are put into an original pattern is usually from about −10 to 50° C. The temperature is preferably from −5 to 40° C., more preferably from 0 to 35° C. in order to keep the bench life certainly.

The working period from a time just after the mixing into the mixed sands to the end of the putting of the mixed sands into the original pattern is usually from about 1 to 9 minutes. In a case where reclaimed sands that are artificial sands produced by a fusion method are conventionally used to produce a mold through a self-curing molding process, the drying of the mixed sands advances remarkably when the working period is 10 minutes or more. Thus, the workability deteriorates. According to the curing agent composition of the present invention, even when the working period is 10 minutes or more, the drying of the mixed sands can be prevented. For example, in the case of using the curing agent composition of the present invention to produce a mold having a complicated shape, the working period is preferably 10 minutes or more, more preferably 12 minutes or more, even more preferably 15 minutes or more. In this case, the advantageous effects of the present invention are more remarkably produced. From the viewpoint of the productivity, the working period is preferably 60 minutes or less, more preferably 30 minutes or less.

The content of the curing agent composition in the mixed sands is preferably from 0.01 to 5 parts by weight, more preferably from 0.1 to 3 parts by weight for 100 parts by weight of the refractory particles from the viewpoint of the mold strength. The content of the water-soluble phenol resin in the mixed sands, as the content of any solid in the resin, is from 0.1 to 10 parts by weight, more preferably from 0.5 to 5 parts by weight for 100 parts by weight of the refractory particles from the viewpoint of the mold strength, the workability, odor and costs. The method for yielding the mixed sands may be a method of adding the individual components to a batch mixer and then mixing the components with each other therein, or a method of supplying the individual components into a continuous mixer, and then mixing the components with each other therein.

In the present invention, other additives, such as a silane coupling agent and urea, may be blended with the mixed sands. Examples of the silane coupling agent include γ-(2-amino)propylmethyldimethoxysilane, γ-aminopropyltrimethoxysilane, γ-aminopropyltriethoxysilane, γ-glycidoxypropyltrimethoxysilane, N-β(aminoethyl)γ-aminopropylmethyldimethoxysilane or the like. The blend amount of the silane coupling agent is preferably from 0. 001 to 10 parts by weight, more preferably from 0.02 to 1 part by weight for 100 parts by weight of (any solid in) the water-soluble phenol resin.

The process of the present invention for the production of molds is suitable for molding for producing a nonferrous alloy casting such as an aluminum casting, a steel casting, an iron casting, and some other casting. However, the use of the process is not limited to the use of any casting.

### EXAMPLES

Hereinafter, a description will be made about working examples for demonstrating the present invention specifically, and others. The atmosphere temperature when any mixed sand species was put into an original pattern, the atmosphere temperature when the drying of the surface of the mixed sands was evaluated, and the atmosphere temperature when each of the compressive strengths (concerned) was evaluated were each set to 25° C. (at 55% RH).

<Method for Preparing Reclaimed Sands that were Artificial Sands>

To 100 parts by weight of new sands that were artificial alumina sands (ESPEARL #40L, manufactured by Yamakawa Sangyo Co., Ltd.) produced by a fusion method were added 1.2 parts by weight of a water-soluble phenol resin (KAO STEP SH-8010, manufactured by Kao-Quaker Co., Ltd.), and 0.3 part by weight of triacetin as a curing agent for the water-soluble phenol resin, and then these components were mixed with each other to yield mixed sands. The mixed sands were used to shape a mold. The resultant mold was used to cast a casting material FC-250 (S/M=4 wherein S/M represents the ratio of the weight (S) of the mold to the weight (W) of the casting). The sands were collected and crushed by means of a crusher. The resultant was reclaimed by use of an M type rotary reclaimer manufactured by Nippon Chuzo Co., Ltd. This step was repeated 10 times to yield reclaimed sands (LOI: 0.6% by weight). The sands were used in evaluations described below. As for each of Example 4 and Comparative Example 2, the reclaimed sands were mixed with the same new sands ESPEARL #40L under a condition that the ratio by weight of the reclaimed sands to the new sands was 70/30. The mixture was used. About Reference Example 1, the reclaimed sands were mixed with the same new sands ESPEARL #40L under a condition that the ratio by weight of the reclaimed sands to the new sands was 60/40. The mixture was used.

<Evaluation of Drying of Surface of Mixed Sands>

To 100 parts by weight of each of the alumina sand species shown in Table 1 were added 1.2 parts by weight of a water-soluble phenol resin (KAO STEP SH-8010, manufactured by Kao-Quaker Co., Ltd.) and 0.3 part by weight of a curing agent composition shown in Table 1. These components were mixed with each other to yield mixed sands. The mixed sands were allowed to stand in an open state that the sands were exposed to the outside air. At intervals of 1 minute just after the end of the mixing, the dry state of the surface of the mixed sands was checked by a touch with fingers to measure the period until the mixed sands were dried. The wording “the state that the surface of the mixed sands was dried” means that the wetness of the mixed sands was lost so that the sand particles were fixed/bonded to each other. Furthermore, about the dry state of the surface of the mixed sands after 10 minutes from the time just after the end of the mixing, an evaluation was made by a touch with fingers in accordance with the following criterion:

Evaluating Criterion of the Drying State:
A: the sand particles were not fixed/bonded to each other so that the sands had a wetness equivalent to that of the sands just after the mixing.
B: the sand particles were not fixed/bonded to each other but the sands did not have a wetness equivalent to that of the sands just after the mixing.
C: the sand particles were fixed/bonded to each other.

<Each Compressive Strength After 24 Hours>

To 100 parts by weight of each of the alumina sand species shown in Table 1 were added 1.2 parts by weight of a water-soluble phenol resin (KAO STEP SH-8010, manufactured by Kao-Quaker Co., Ltd.) and 0.3 part by weight of one of the curing agent compositions shown in Table 1. These components were mixed with each other to yield mixed sands. The resultant mixed sands were of two species described below, and the two sand species were each put into an original pattern to shape the sands into a test piece (50 mm×50 mm in diameter). The two species were the mixed sands just after the mixing, and those allowed to stand still (atmosphere temperature: the same as when the mixed sands were put into the original pattern) after the mixing. About each of the pieces after 24 hours elapsed at 25° C. (55% RH) from the shaping into the piece, the compressive strength (mold strength) thereof was measured by a method described in JIS Z 2604-1976 (compressive rate: 5 mm/sec.). The compressive strength was defined as the value obtained by dividing the load applied by the sectional area of the test piece.

TABLE 1

| | | | Curing agent composition (content by percentage | | | | | | |
|---|---|---|---|---|---|---|---|---|---|
| | | | (% by weight) of each component in the curing | | | | | | |
| | Alumina sands (ratio | | agent composition) | | | | | | |
| | by weight between the | | Ester compounds | | | Drying preventing components | | | |
| | individual sand species) | | Triethylene | | Ethylene | | 3- | | |
| | Reclaimed | New | glycol | | glycol | Triethylene | Phenylpropane- | Benzyl | Other components |
| | sands | sands | diacetate | Triacetin | diacetate | glycol | 1-ol | alcohol | Resorcin |
| Example 1 | 100 | 0 | 48 | 20 | 23 | 0 | 0 | 0 | 9 |
| Example 2 | 100 | 0 | 48 | 15 | 23 | 0 | 0 | 5 | 9 |
| Example 3 | 100 | 0 | 45 | 11 | 22 | 0 | 0 | 13 | 9 |
| Example 4 | 70 | 30 | 45 | 11 | 22 | 0 | 0 | 13 | 9 |
| Example 5 | 100 | 0 | 0 | 11 | 67 | 0 | 0 | 13 | 9 |
| Example 6 | 100 | 0 | 0 | 11 | 67 | 0 | 13 | 0 | 9 |
| Example 7 | 100 | 0 | 0 | 11 | 67 | 13 | 0 | 0 | 9 |
| Example 8 | 100 | 0 | 45 | 11 | 22 | 13 | 0 | 0 | 9 |
| Example 9 | 100 | 0 | 45 | 11 | 22 | 0 | 13 | 0 | 9 |
| Example 10 | 100 | 0 | 45 | 21 | 12 | 0 | 0 | 13 | 9 |
| Example 11 | 100 | 0 | 45 | 11 | 22 | 0 | 0 | 22 | 0 |
| Example 12 | 100 | 0 | 45 | 9 | 19 | 13 | 0 | 0 | 9 |
| Example 13 | 100 | 0 | 100 | 0 | 0 | 0 | 0 | 0 | 0 |
| Comparative | 100 | 0 | 0 | 29 | 66 | 0 | 0 | 0 | 5 |
| Example 1 | | | | | | | | | |
| Comparative | 70 | 30 | 0 | 29 | 66 | 0 | 0 | 0 | 5 |
| Example 2 | | | | | | | | | |
| Comparative | 100 | 0 | 0 | 11 | 67 | 0 | 0 | 0 | 9 |
| Example 3 | | | | | | | | | |
| Comparative | 100 | 0 | 0 | 11 | 67 | 0 | 0 | 0 | 9 |
| Example 4 | | | | | | | | | |
| Reference | 60 | 40 | 0 | 29 | 66 | 0 | 0 | 0 | 5 |
| Example 1 | | | | | | | | | |

| | Curing agent composition (content by percentage | | | Evaluation of | | | |
|---|---|---|---|---|---|---|---|
| | (% by weight) of each component in the curing | | | mixed sand surface | | Compressive strength | |
| | agent composition) | | | drying | | (MPa) after 24 hours | |
| | Other components | | | Drying | Dry state | Sands were put into | Sands were put into |
| | Polyoxyethylene | | Ethylene | period | after 10 | original mold just | original mold after allowed |
| | (5) lauryl ether | 1-Butanol | glycol | (min.) | minutes | after mixing | to stand for 10 minutes |
| Example 1 | 0 | 0 | 0 | 10 | B | 2.2 | 0.7 |
| Example 2 | 0 | 0 | 0 | 12 | B | 2.5 | 0.9 |
| Example 3 | 0 | 0 | 0 | 14 | A | 2.7 | 1.3 |
| Example 4 | 0 | 0 | 0 | 16 | A | 2.9 | 1.5 |
| Example 5 | 0 | 0 | 0 | 12 | A | 2.6 | 1.1 |
| Example 6 | 0 | 0 | 0 | 12 | A | 2.5 | 1.1 |
| Example 7 | 0 | 0 | 0 | 13 | A | 2.8 | 1.3 |
| Example 8 | 0 | 0 | 0 | 17 | A | 3.0 | 1.7 |
| Example 9 | 0 | 0 | 0 | 12 | A | 2.6 | 1.2 |
| Example 10 | 0 | 0 | 0 | 11 | B | 2.5 | 0.9 |
| Example 11 | 0 | 0 | 0 | 15 | A | 2.5 | 1.1 |
| Example 12 | 5 | 0 | 0 | 17 | A | 2.9 | 1.6 |
| Example 13 | 0 | 0 | 0 | 20 | A | 1.6 | 1.1 |
| Comparative | 0 | 0 | 0 | 3 | C | 2.0 | 0.4 |
| Example 1 | | | | | | | |
| Comparative | 0 | 0 | 0 | 6 | C | 2.1 | 0.6 |
| Example 2 | | | | | | | |
| Comparative | 0 | 13 | 0 | 7 | C | 2.2 | 0.6 |
| Example 3 | | | | | | | |
| Comparative | 0 | 0 | 13 | 8 | C | 2.3 | 0.6 |
| Example 4 | | | | | | | |
| Reference | 0 | 0 | 0 | 12 | A | 3.2 | 2.0 |
| Example 1 | | | | | | | |

As shown in Table 1, Examples 1 to 13 each showed a good value about each of the evaluation items. However, Comparative Examples 1 to 4 each gave a clearly poorer result than Examples 1 to 13 about at least one of the evaluation items. Reference Example 1 had a higher proportion of the new sands (the reclaimed sands/the new sands=60/40) than Examples 1 to 13, so that the mixed sands were not remarkably dried. In a case where mixed sands were prepared (in the same as) in each of Examples 1 to 12, the drying preventing component was not incorporated into the curing agent composition but after the curing agent composition was formulated, the drying preventing component was separately incorporated thereinto. Even in this case, the same results as in each of Examples 1 to 12, shown in Table 1, were obtained.

1-10. (canceled)

11. A process for producing a mold, comprising a step of mixing refractory particles, a water-soluble phenol resin, and a curing agent composition comprising an ester compound, thereby yielding mixed sands, and a step of putting the mixed sands into an original pattern to shape the sands,
wherein the refractory particles comprise reclaimed sands that are artificial sands produced by a fusion method in a proportion of 70% or more by weight,
the curing agent composition comprises at least one selected from triethylene glycol diacetate, triethylene glycol, 3-phenylpropane-1-ol, and benzyl alcohol, and
the mixed sands or the curing agent composition further comprise resorcin.

12. The process for producing the mold according to claim 11, wherein the artificial sands are alumina sands.

13. The process for producing the mold according to claim 11, wherein the working period from a time just after the end of the mixing to a time when the putting of the sands into the original pattern is finished is 10 minutes or more.

14. The process for producing the mold according to claim 12, wherein the working period from a time just after the end of the mixing to a time when the putting of the sands into the original pattern is finished is 10 minutes or more.

15. The process for producing the mold according to claim 11, wherein the curing agent composition comprises at least one ester compound selected from the group consisting of triethylene glycol diacetate, triacetin and ethylene glycol diacetate, and further comprises at least one drying preventing component selected from the group consisting of triethylene glycol, 3-phenylpropane-1-ol, and benzyl alcohol.

16. The process for producing the mold according to claim 15, wherein the ratio by weight of the drying preventing component to the ester compound is from 4/96 to 30/70.

17. A composition for a mold, which comprises refractory particles comprising reclaimed sands that are artificial sands produced by a fusion method in a proportion of 70% or more by weight, a water-soluble phenol resin, and a curing agent composition comprising an ester compound, and
which comprises at least one selected from the group consisting of triethylene glycol diacetate, triethylene glycol, 3-phenylpropane-1-ol, and benzyl alcohol, and
further comprises resorcin.

18. The composition for a mold according to claim 17, wherein the artificial sands are alumina sands.

19. The composition for a mold according to claim 17, wherein the working period from a time just after the end of the mixing to a time when the putting of the sands into the original pattern is finished is 10 minutes or more.

20. The composition for a mold according to claim 18, wherein the working period from a time just after the end of the mixing to a time when the putting of the sands into the original pattern is finished is 10 minutes or more.

21. The composition for a mold according to claim 17, wherein the curing agent composition comprises at least one ester compound selected from the group consisting of triethylene glycol diacetate, triacetin and ethylene glycol diacetate, and further comprises at least one drying preventing component selected from the group consisting of triethylene glycol, 3-phenylpropane-1-ol, and benzyl alcohol.

22. The composition for a mold according to claim 21, wherein the ratio by weight of the drying preventing component to the ester compound is from 4/96 to 30/70.

23. A curing agent composition which comprises an ester compound, and is used at the time of using refractory particles comprising reclaimed sands that are artificial sands produced by a fusion method in a proportion of 70% or more by weight, and a water-soluble phenol resin to produce a mold, and
which comprises at least one selected from the group consisting of triethylene glycol diacetate, triethylene glycol, 3-phenylpropane-1-ol, and benzyl alcohol, and
further comprises resorcin.
